(19) United States
(12) Patent Application Publication
(10) Pub. No.: US 2021/0285122 A1
(43) Pub. Date: Sep. 16, 2021

(54) HIGH-GROSS MANUFACTURING METHOD FOR MAGNESIUM ALLOY OBJECT AND HIGH-GROSS MAGNESIUM ALLOY STRUCTURE

(71) Applicant: Ju Teng International Holdings Ltd., Hong Kong (HK)

(72) Inventors: Hsiang-Jui WANG, Taipei (TW); Shun-Jie YANG, Taipei (TW); Cheng-Ping HSIAO, Taipei (TW)

(21) Appl. No.: 16/814,368

(22) Filed: Mar. 10, 2020

(51) Int. Cl. C25D 11/30; B05D 7/14; B05D 7/00; B05D 1/02; C25D 13/20; C25D 11/02; C23F 17/00

(52) U.S. Cl. CPC C25D 11/30; B05D 7/14; B05D 7/52; B05D 2202/20; C25D 13/20; C25D 11/026; C23F 17/00; B05D 1/02

(57) ABSTRACT

A high-gross manufacturing method for magnesium alloy object includes providing a magnesium alloy object; performing micro-arc oxidation or conversion coating treatment on the magnesium alloy object to form oxide film on a surface of the magnesium alloy object; spraying a paint layer on MAO-treated or conversion coating-treated surface of the magnesium alloy object to protect the magnesium alloy object; performing CNC high gross cutting to cut away part of paint layer and part of the oxide film to expose metallic main body; using specific conversion coating solution to passivate the magnesium alloy object; and spraying UV curable paint on the surface of the magnesium alloy object to provide corrosion protection. The present invention also provides a high-gross magnesium alloy structure.

### BACKGROUND OF THE INVENTION

### 1. Technical field

The present invention relates to high-gross manufacturing method for magnesium alloy object and high-gross magnesium alloy structure for casing of electronic device.

### 2. Description of Prior Art

The casing/shell of the electronic devices may include a plurality of structural elements. For example, the laptop computer may include display and main body. The display may include upper cover and display main body, while the main body may include keyboard cover and bottom structure. The above mentioned main body and keyboard cover may contain any suitable material.

The casing/shell of the electronic devices, such as casing of portable electronic devices, may be in frequent contact with other objects such as table, user hand, ground, magnesium alloy object such that the casing/shell of the electronic devices may have deformation. The casing/shell may be damaged, the cover paint of the casing/shell may be worn out and the protection layer may be broken due to collision or rub. The metallic object on casing/shell of the electronic devices may be rust-eaten such that it cannot provide protection function and is not appealing for consumer for appearance.

### SUMMARY OF THE INVENTION

The object of the present invention is to provide magnesium alloy object with corrosion protection after high-gross treatment.

According to a first aspect of the present invention, the present invention provides a high-gross manufacturing method for magnesium alloy object. The method provides a magnesium alloy object; performs micro-arc oxidation (MAO) or conversion coating treatment to form oxide film on the surface of the magnesium alloy object to enhance corrosion protection function; sprays paint on the MAO-treated or coating-treated layer to enhance appearance and protect the magnesium alloy object; CNC high-gross cuts away part of the paint layer/oxide film (passivation layer) to expose metallic main body of the magnesium alloy object such that the exposed metallic main body has high gross surface; uses specific conversion coating solution such as phosphate, zirconate, organic/inorganic oxane mixed solution to passivate the activity of the magnesium alloy object and maintain high gross; applies ED/UV protective paint to the exposed surface obtained in previous two steps to achieve corrosion protection.

According to a second aspect of the present invention, the present invention provides a high-gross manufacturing method for magnesium alloy object. The method provides a magnesium alloy object; performs micro-arc oxidation (MAO) or conversion coating treatment to form oxide film on the surface of the magnesium alloy object to enhance corrosion protection function; uses laser to remove the MAO-treated or coating-treated protection layer on the surface of the magnesium alloy object and expose the metallic surface of the magnesium alloy object; performs conversion coating treatment for the laser-treated metallic surface to passivate the magnesium alloy object; sprays conductive paint on the laser-treated and passivated surface; sprays paint to enhance appearance and protect the magnesium alloy object; cuts away part of the magnesium alloy object to expose metallic main body such that the metallic main body has high gross; uses specific conversion coating solution such as phosphate, zirconate, organic/inorganic oxane mixed solution to passivate the activity of the magnesium alloy object and maintain high gross; applies ED/UV protective paint to the exposed surface obtained in previous two steps to achieve corrosion protection.

According to a third aspect of the present invention, the present invention provides a high-gross manufacturing method for magnesium alloy object. The method provides a magnesium alloy object; performs micro-arc oxidation (MAO) or conversion coating treatment to form oxide film on the surface of the magnesium alloy object to enhance corrosion protection function; sprays paint on the MAO-treated or coating-treated layer to enhance appearance and protect the magnesium alloy object; CNC high-gross cuts away part of the paint layer/oxide film (passivated layer) to expose metallic main body such that the exposed metallic main body has high gross surface; uses specific conversion coating solution such as phosphate, zirconate, organic/inorganic oxane mixed solution to passivate the activity of the magnesium alloy object and maintain high gross; applies UV protective paint to all of the magnesium alloy object to achieve corrosion protection.

According to a fourth aspect of the present invention, the present invention provides a high-gross manufacturing method for magnesium alloy object. The method provides a magnesium alloy object; performs micro-arc oxidation (MAO) or conversion coating treatment to form oxide film on the surface of the magnesium alloy object to enhance corrosion protection function; sprays conductive paint on the MAO-treated or coating-treated layer; sprays paint on the conductive painted surface to enhance appearance and protect the magnesium alloy object; CNC high-gross cuts away part of the paint layer/oxide film (passivated layer) to expose metallic main body such that the exposed metallic main body has high-gross surface and the high gross surface is also electrically conductive; uses specific conversion coating solution such as phosphate, zirconate, organic/inorganic oxane mixed solution to passivate the activity of the magnesium alloy object and maintain high gross; applies ED protective paint to protect the high-gross surface to achieve corrosion protection.

The magnesium alloy object according to the present invention is subject to micro-arc oxidation (MAO) or conversion coating treatment, painted with conductive paint, subject to CNC high-gross treatment and then painted with protective paint, and can achieve corrosion protection. Moreover, the high-gross surface of the magnesium alloy object is passivated and the passivated surface still has metallic gross. The magnesium alloy object is added with conductive layer to increase the ED coverage area and to enhance corrosion protection ability.

### BRIEF DESCRIPTION OF DRAWINGS

FIG. 1 shows the steps in the high-gross manufacturing method for magnesium alloy object according to the first embodiment of the present invention.

FIG. 2 shows the steps in the high-gross manufacturing method for magnesium alloy object according to the second embodiment of the present invention.

FIG. 3 shows the steps in the high-gross manufacturing method for magnesium alloy object according to the third embodiment of the present invention.

FIG. 4 shows the steps in the high-gross manufacturing method for magnesium alloy object according to the fourth embodiment of the present invention.

FIGS. 5A to 5E show the sectional view of structure corresponding to the magnesium alloy object according to the first embodiment of the present invention.

FIGS. 6A to 6G show the sectional view of structure corresponding to the magnesium alloy object according to the second embodiment of the present invention.

FIGS. 7A to 7E show the sectional view of structure corresponding to the magnesium alloy object according to the third embodiment of the present invention.

FIGS. 8A to 8E show the sectional view of structure corresponding to the magnesium alloy object according to the fourth embodiment of the present invention.

### DETAILED DESCRIPTION OF THE INVENTION

Reference will now be made to the drawing figures to describe the present disclosure in detail. It will be understood that the drawing figures and exemplified example of present disclosure are not limited to the details thereof.

According to the first embodiment, the present invention provides a high-gross manufacturing method for magnesium alloy object. The method provides a magnesium alloy object; performs micro-arc oxidation (MAO) or conversion coating treatment to form oxide film on the surface of the magnesium alloy object to enhance corrosion protection function; sprays paint on the MAO-treated or coating-treated layer to enhance appearance and protect the magnesium alloy object; CNC high-gross cuts away part of the paint layer/oxide film (passivation layer) to expose metallic main body of the magnesium alloy object such that the exposed metallic main body has high gross surface; uses specific conversion coating solution such as phosphate, zirconate, organic/inorganic oxane mixed solution to passivate the activity of the magnesium alloy object and maintain high gross; applies ED/UV protective paint to the exposed surface obtained in previous two steps to achieve corrosion protection.

The magnesium alloy object is, for example, magnesium alloy object substrate.

According to the second embodiment, the present invention provides a high-gross manufacturing method for magnesium alloy object. The method provides a magnesium alloy object; performs micro-arc oxidation (MAO) or conversion coating treatment to form oxide film on the surface of the magnesium alloy object to enhance corrosion protection function; uses laser to remove the MAO-treated or coating-treated protection layer on the surface of the magnesium alloy object and expose the metallic surface of the magnesium alloy object; performs conversion coating treatment for the laser-treated metallic surface to passivate the magnesium alloy object; sprays conductive paint on the laser-treated and passivated surface; sprays paint to enhance appearance and protect the magnesium alloy object; cuts away part of the magnesium alloy object to expose metallic main body such that the metallic main body has high gross; uses specific conversion coating solution such as phosphate, zirconate, organic/inorganic oxane mixed solution to passivate the activity of the magnesium alloy object and maintain high gross; applies ED/UV protective paint to the exposed surface obtained in previous two steps to achieve corrosion protection.

According to the third embodiment, the present invention provides a high-gross manufacturing method for magnesium alloy object. The method provides a magnesium alloy object; performs micro-arc oxidation (MAO) or conversion coating treatment to form oxide film on the surface of the magnesium alloy object to enhance corrosion protection function; sprays paint on the MAO-treated or coating-treated layer to enhance appearance and protect the magnesium alloy object; CNC high-gross cuts away part of the paint layer/oxide film (passivated layer) to expose metallic main body such that the exposed metallic main body has high gross surface; uses specific conversion coating solution such as phosphate, zirconate, organic/inorganic oxane mixed solution to passivate the activity of the magnesium alloy object and maintain high gross; applies UV protective paint to all of the magnesium alloy object to achieve corrosion protection.

According to the fourth embodiment, the present invention provides a high-gross manufacturing method for magnesium alloy object. The method provides a magnesium alloy object; performs micro-arc oxidation (MAO) or conversion coating treatment to form oxide film on the surface of the magnesium alloy object to enhance corrosion protection function; sprays conductive paint on the MAO-treated or coating-treated layer; sprays paint on the conductive painted surface to enhance appearance and protect the magnesium alloy object; CNC high-gross cuts away part of the paint layer/oxide film (passivated layer) to expose metallic main body such that the exposed metallic main body has high-gross surface and the high gross surface is also electrically conductive; uses specific conversion coating solution such as phosphate, zirconate, organic/inorganic oxane mixed solution to passivate the activity of the magnesium alloy object and maintain high gross; applies ED protective paint to protect the high-gross surface to achieve corrosion protection.

The magnesium alloy object according to the present invention is subject to micro-arc oxidation (MAO) or conversion coating treatment, painted with conductive paint, subject to CNC high-gross treatment and then painted with protective paint, and can achieve corrosion protection.

### Micro-Arc Oxidation (MAO)

Micro-arc oxidation (MAO) is also referred to as plasma electrolytic oxidation and can form oxide coating on conductive material such as metallic material. The “metallic material” is referred to as pure metal, metal alloy, intermetallic or compound containing metal. The metallic material may include aluminum, magnesium, titanium and so on. MAO adopts high electric potential to discharge and the resulting plasma may change the structure property of the oxide layer.

MAO establishes minute discharge on the surface of the metallic material dipped in electrolyte. MAO treatment forms relatively thick and substantially crystallized oxide coating. The thickness of the coating layer is, for example, tens or hundreds of micrometer, but it is not limited to specific values. For example, in compliance of various application or arts, the MAO coating may have larger or smaller thickness. The resulting MAO oxide coating is compact and/or extensible and has relatively high hardness, which is in contrary to the oxide layer formed by anode oxidation.

On contrary to deposition treatment, MAO is chemical conversion technique. The oxide layer formed by MAO process is resulted from the oxidation of the lower metallic layer, which is not oxide layer formed by deposited layer on object. In comparison with deposition processing (such as spraying), MAO coating layer has higher adhesion to the lower layer metal material.

### Conversion Coating Treatment

Conversion coating treatment obtains coating with metal compound by chemically treating or electro-chemically treating metal surface, and has function of corrosion protection, paint bonding, metal coloring, and chemical polishing etc. There are many kinds of conversion coating treatment such as chromate treatment, phosphate treatment, non- chromium-based treatment, metal coloring, and chemical polishing etc. The conversion coating treatment has advantages of good corrosion protection, good bonding, good electric insulation, non-binding to molten metal and so on. The conversion coating treatment is widely used for treatment of steel, aluminum, zinc, stainless steel, copper and magnesium.

### CNC High-Gross Treatment

Computer Numerical Control (CNC) uses computer to compile the NC program input to memory of the control system and uses shift control system to drive motor through driver. CNC treatment is used to cut and process the designed component. The computer-controlled machine is usually called as CNC directly. Taking diamond knife as example, it uses natural diamond knife to process soft metals such as aluminum alloy and copper alloy to obtain fine resolution lathing with optical mirror. The optical metal mirror has high reflection rate after processing by diamond knife. The recent development of super-fine CNC lathe provide better non-spherical mirror contour. Besides, the metal surface has high gross effect and has excellent metallic quality after cutting by diamond knife.

As the development of high-performance and high-precision CNC machine and excellent diamond knife, the CNC high gross processing has fast progress. The grinding process is replaced by milling (lathing) process for more mature process. CNC high-gross process uses diamond high-gross knife on precise CNC processing equipment and uses cutting parameters and skill to achieve shining processing face. The material which can be processed by CNC high-gross processing includes acrylic, organic glass, copper alloy, copper piece, aluminum alloy, aluminum object, copper object, magnesium alloy, and zinc alloy and so on.

### Electro-Coating (ED)

Electro-coating (ED) utilizes external electric field to deposit pigment in electrophoresis solution to surface of the magnesium alloy object. ED has the advantages of water-soluble, non-toxic, easy to automatic control and so on, and is extensively applied to automobile, building materials, hardware and home electronic appliance. The principle of ED is described as follows. The resin in the cathode electrophoresis coating has alkaline base group and forms salt soluble to water after reacted with acid. After applying DC current, the acid negative ions move toward anode and the resin ions (with the pigment particles wrapped therein) with positive charge moves toward cathode and then deposit on the cathode. This is the principle of ED and therefore it is also referred to as plating-painting. ED is a complicated electrochemistry reaction and includes four reactions (electrophoresis, electro-plating, electrolyze and electroosmosis) occurring at the same time.

The electro-coating (ED) has advantages of plentiful, uniform, smooth and shining coating. The hardness, bonding, corrosion-resisting, shock-resisting and porousness of ED layer is better than that of the other coating layer.

### UV (Ultraviolet) Paint

Ultraviolet paint is ultraviolet curable paint. UV paint is usually referred to as photo-curable coating (photosensitive coating). UV paint uses UV light as curing source and is also referred to as UV curable paint. The UV paint can be fast and easily cured to form a film on combustible material such as paper, plastic, leather or wood without the need of heating. The UV paint mainly comprises photosensitive resin, photosensitizer and diluent and is added with certain additives such as heat stabilizers. The color UV paint also contains pigment and filler. The photosensitive resin is generally low-molecular-weight resin with unsaturated bond and is, for example, unsaturated polyester or acrylic acid based oligomer. The photosensitizer is a compound tending to generate free radical after receiving UV light, and is for example benzophenone or benzoin alkanes ether. The diluent is used for reduce paint viscosity and also cured into film for active dilution. The diluent is, for example, styrene or acrylate. The photo-curable coating has the advantages of short curing time (from less-than-1 second to several minutes), low curing temperature, low volatilization, energy saving, resource saving, pollution-free and high efficiency.

### Manufacturing Method

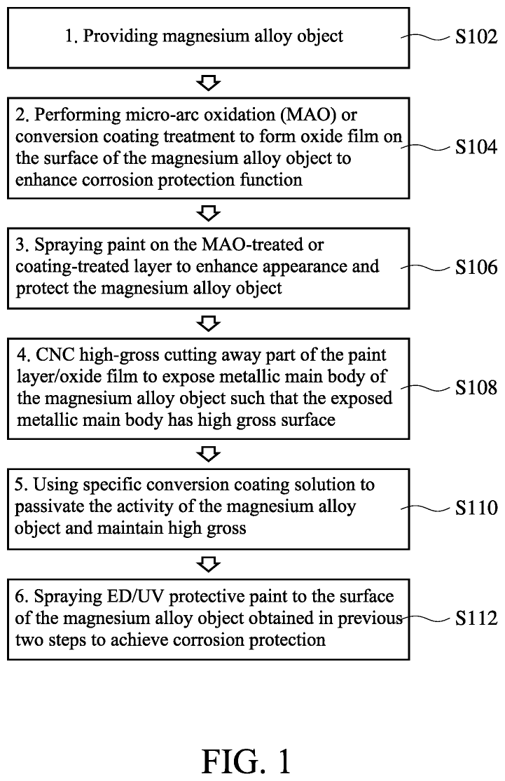

At least one part of the shell structure disclosed here can be manufactured by steps of arbitrary number. FIG. 1 shows exemplary steps for this manufacturing method. The method shown in FIG. 1 includes processing a first surface of the metallic material by micro-arc oxidation (MAO) treatment (S101). The oxidation technology can involve any suitable and various process. Depending on the involved material and skill, any suitable oxidation parameter can be used. Except specifically defined, the terms “first”, “second”, “third” and so on only indicate individual object/article and do not mean ordinal or order.

FIG. 1 shows the steps in the high-gross manufacturing method for magnesium alloy object according to the first embodiment of the present invention. The method includes: providing a magnesium alloy object (S102); performing micro-arc oxidation (MAO) or conversion coating treatment to form oxide film on the surface of the magnesium alloy object to enhance corrosion protection function (S104); spraying paint on the MAO-treated or coating-treated layer to enhance appearance and protect the magnesium alloy object (S106); CNC high-gross cutting away part of the first paint layer/oxide film (passivation layer) to expose metallic main body of the magnesium alloy object such that the exposed metallic main body has high gross surface (S108); using specific conversion coating solution such as phosphate, zirconate, organic/inorganic oxane mixed solution to passivate the activity of the magnesium alloy object and maintain high gross (S110); and spraying ED/UV protective paint to the exposed surface obtained in previous two steps to achieve corrosion protection (S112). In CNC high-gross process, the metallic surface is cut by knife and has high-gross effect and metallic appearance. ED painting process uses external electric field to deposit the pigment in the electrophoresis solution to surface of the magnesium alloy object. UV painting process uses UV light to cure paint. The detail of the above two processes are omitted here for brevity.

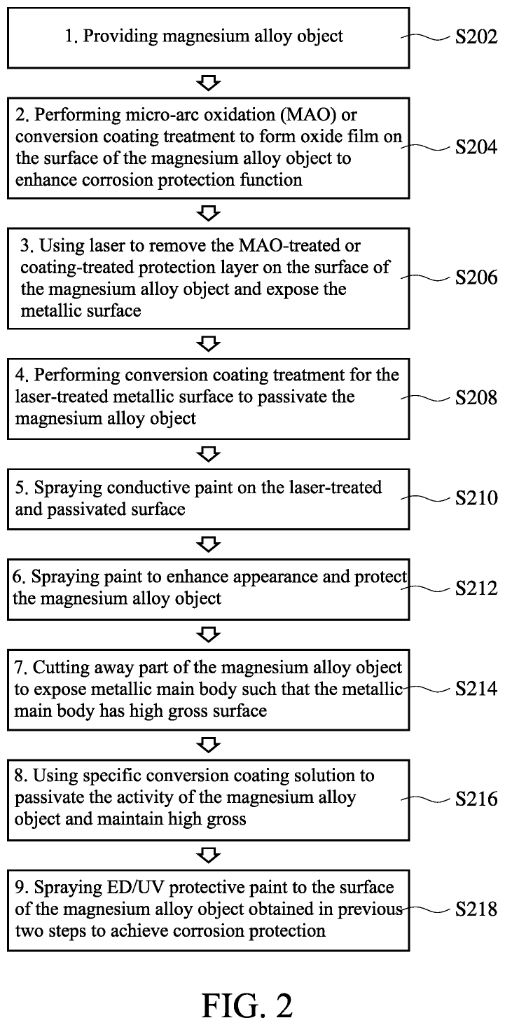

FIG. 2 shows the steps in the high-gross manufacturing method for magnesium alloy object according to the second embodiment of the present invention. The method includes: providing a magnesium alloy object (S202); performing micro-arc oxidation (MAO) or conversion coating treatment to form oxide film on the surface of the magnesium alloy object to enhance corrosion protection function (S204); using laser to remove the MAO-treated or coating-treated protection layer on the surface of the magnesium alloy object and expose the metallic surface of the magnesium alloy object (S206); performing conversion coating treatment for the laser-treated metallic surface to passivate the magnesium alloy object (S208); spraying conductive paint on the laser-treated and passivated surface (S210); spraying paint to form the second paint layer to enhance appearance and protect the magnesium alloy object (S212); cutting away part of the magnesium alloy object to expose metallic main body such that the metallic main body has high gross (S214); using specific conversion coating solution such as phosphate, zirconate, organic/inorganic oxane mixed solution to passivate the activity of the magnesium alloy object and maintain high gross (S216); spraying ED/UV protective paint to the surface of the magnesium alloy object obtained in previous two steps to achieve corrosion protection (S218).

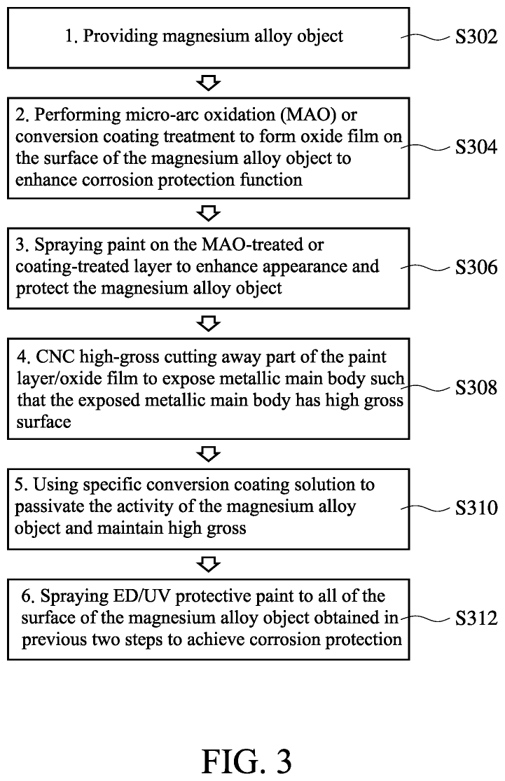

FIG. 3 shows the steps in the high-gross manufacturing method for magnesium alloy object according to the third embodiment of the present invention. The method includes: providing a magnesium alloy object (S302); performing micro-arc oxidation (MAO) or conversion coating treatment to form oxide film on the surface of the magnesium alloy object to enhance corrosion protection function (S304); spraying paint on the MAO-treated or coating-treated layer to form a third paint layer to enhance appearance and protect the magnesium alloy object (S306); CNC high-gross cutting away part of the paint layer/oxide film (passivated layer) to expose metallic main body such that the exposed metallic main body has high gross surface (S308); using specific conversion coating solution such as phosphate, zirconate, organic/inorganic oxane mixed solution to passivate the activity of the magnesium alloy object and maintain high gross (S310); spraying UV protective paint to all surface of the magnesium alloy object to achieve corrosion protection (S312). The third embodiment of the present invention is different with the first embodiment of the present invention in that the all surface of the magnesium alloy object is sprayed with UV paint to provide corrosion protection.

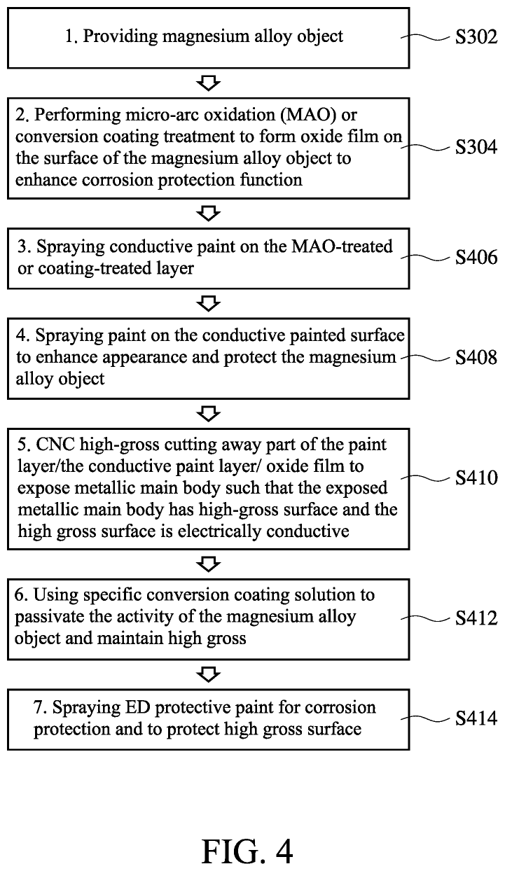

FIG. 4 shows the steps in the high-gross manufacturing method for magnesium alloy object according to the fourth embodiment of the present invention. The method includes: providing a magnesium alloy object (S402); performing micro-arc oxidation (MAO) or conversion coating treatment to form oxide film on the surface of the magnesium alloy object to enhance corrosion protection function (S404); spraying conductive paint on the MAO-treated or coating-treated layer (S406); spraying paint on the conductive painted surface to form a fourth paint layer and to enhance appearance and protect the magnesium alloy object (S408); CNC high-gross cutting away part of the fourth paint layer/conductive paint layer/oxide film (passivated layer) to expose metallic main body such that the exposed metallic main body has high-gross surface and the high gross surface is also electrically conductive (S410); using specific conversion coating solution such as phosphate, zirconate, organic/inorganic oxane mixed solution to passivate the activity of the magnesium alloy object and maintain high gross (S412); spraying ED protective paint to protect the high-gross surface to achieve corrosion protection (S414).

The magnesium alloy object according to the present invention is subject to micro-arc oxidation (MAO) or conversion coating treatment, painted with conductive paint, subject to CNC high-gross treatment and then painted with protective paint, and can achieve corrosion protection. Moreover, the high-gross surface of the magnesium alloy object is passivated and the passivated surface still has metallic gross. The magnesium alloy object is added with conductive layer to increase the ED coverage area and to enhance corrosion protection ability.

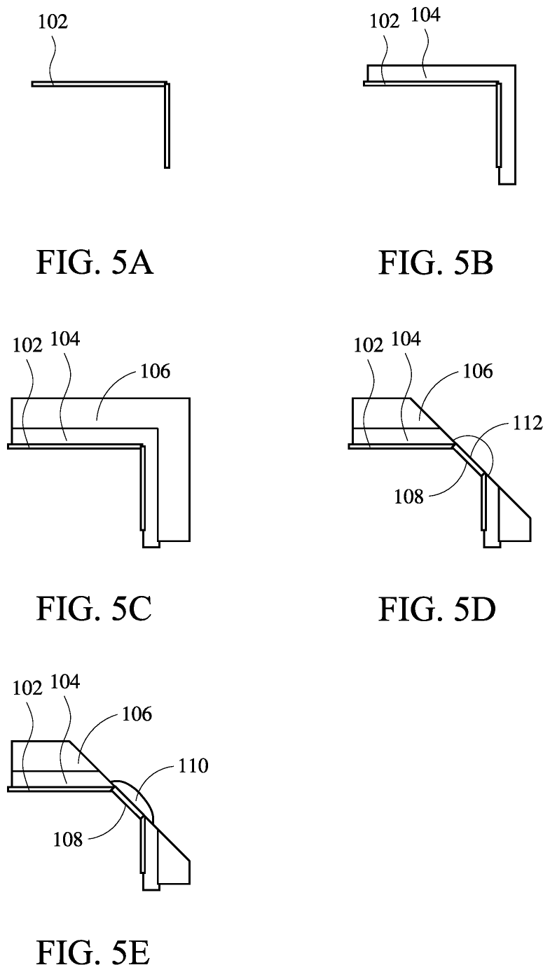

FIGS. 5A to 5E show the sectional view of structure corresponding to the magnesium alloy object according to the first embodiment of the present invention shown in FIG. 1. The magnesium alloy object 102 is processed with micro-arc oxidation (MAO) or conversion coating treatment to form oxide film 104 on the surface of the magnesium alloy object 102, thus enhance corrosion protection function. After the MAO or conversion coating treatment, the surface of the magnesium alloy object 102 is sprayed by paint to form a first paint layer 106. According to one embodiment, a functional paint layer (the first paint layer) is arranged on the oxidized first surface, where the functional paint layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer. Therefore, the magnesium alloy object has appealing appearance and the surface thereof can be protected. Afterward, part of the first paint layer 106/passivation layer (oxide film) 104 is CNC high-gross cut away to expose metallic main body of the magnesium alloy object such that the exposed metallic main body has high gross surface. The activity of the magnesium alloy object 102 is passivated and the magnesium alloy object 102 maintains high gross by using specific conversion coating solution such as phosphate, zirconate, organic/inorganic oxane mixed solution. The exposed surface of the magnesium alloy object 102, which is formed after the previous two steps, is applied with ED/UV protective paint to form the second paint layer 110 for corrosion protection.

The surface of the magnesium alloy object 102 is provided with oxide film 104 to enhance corrosion protection function. The magnesium alloy object 102 with oxide film 104 is also provided with first paint layer 106 thereon. According to one embodiment, a functional paint layer (the first paint layer) is arranged on the oxidized first surface, where the functional paint layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer. Therefore, the magnesium alloy object has appealing appearance and the surface thereof can be protected. Part of the first paint layer 106/passivation layer (oxide film) 104 is cut away to expose and to form a cut portion 108 such that the exposed metallic main body has high gross surface. A second paint layer 110 is arranged on the cut portion 108. According to one embodiment, a functional paint layer (the second paint layer) is arranged on the oxidized first surface, where the functional paint layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer. The metallic main body 112 of the magnesium alloy object 102 and the oxide film 104 is covered by the second paint layer 110 to have corrosion protection function.

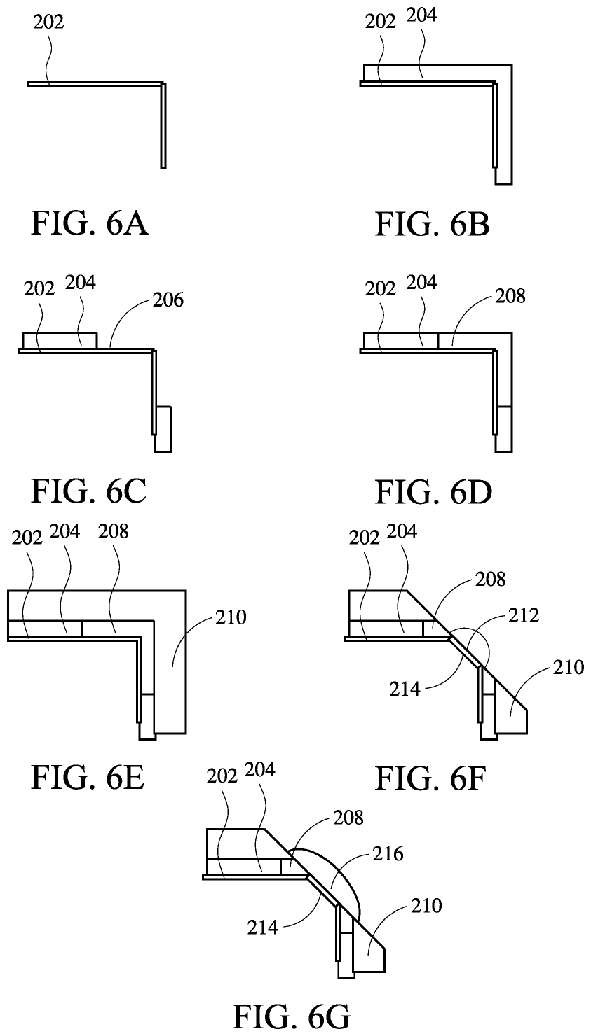

FIGS. 6A to 6G show the sectional view of structure corresponding to the magnesium alloy object according to the second embodiment of the present invention shown in FIG. 2. The magnesium alloy object 202 is processed with micro-arc oxidation (MAO) or conversion coating treatment to form oxide film 204 on the surface of the magnesium alloy object 202, thus enhance corrosion protection function. Part of the MAO-treated or coating-treated protection layer (the oxide film 204) on the surface of the magnesium alloy object 202 is removed by laser to expose the metallic surface 206 of the magnesium alloy object 202. The laser-treated metallic surface 206 is subject to conversion coating treatment to passivate the magnesium alloy object 202. The conductive paint layer 208 is sprayed on the laser-treated and passivated metallic surface 206. The surface of the oxide film 204 and the conductive paint layer 208 are sprayed with paint to form a third paint layer 210 and to enhance appearance. According to one embodiment, a functional paint layer (the third paint layer) is arranged on the oxidized first surface, where the functional paint layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer. Therefore, the surface of the magnesium alloy object 202 can be protected. Afterward, part of the conductive paint layer 208 and the third paint layer 210 is cut away to expose the metallic main body 212 of the magnesium alloy object 202 and to form the cut portion 214 with high gross surface. The activity of the magnesium alloy object 202 is passivated and the magnesium alloy object 202 maintains high gross by using specific conversion coating solution such as phosphate, zirconate, organic/inorganic oxane mixed solution. The exposed surface of the magnesium alloy object 102, which is formed after the previous two steps, is applied with ED/UV protective paint to form the fourth paint layer 216 for corrosion protection.

The surface of the magnesium alloy object 202 is provided with oxide film 204 to enhance corrosion protection function. Part of the protection layer (the oxide film 204) on the surface of the magnesium alloy object 202 is removed to expose the metallic surface 206 of the magnesium alloy object 202. The conductive paint layer 208 is provided on the metallic surface 206. The third paint layer 210 is arranged on the oxide film 204 and the conductive paint layer 208 to protect the magnesium alloy object 202. Part of the conductive paint layer 208 and the third paint layer 210 is cut away to expose the metallic main body 212 of the magnesium alloy object 202 and to form the cut portion 214 with high gross. A fourth paint layer 216 is formed on the magnesium alloy object 202 to cover the metallic main body 212 of the magnesium alloy object 202 and the conductive paint layer 208. According to one embodiment, a functional paint layer (the fourth paint layer) is arranged on the oxidized first surface, where the functional paint layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer. Therefore, the surface of the magnesium alloy object 202 can be protected.

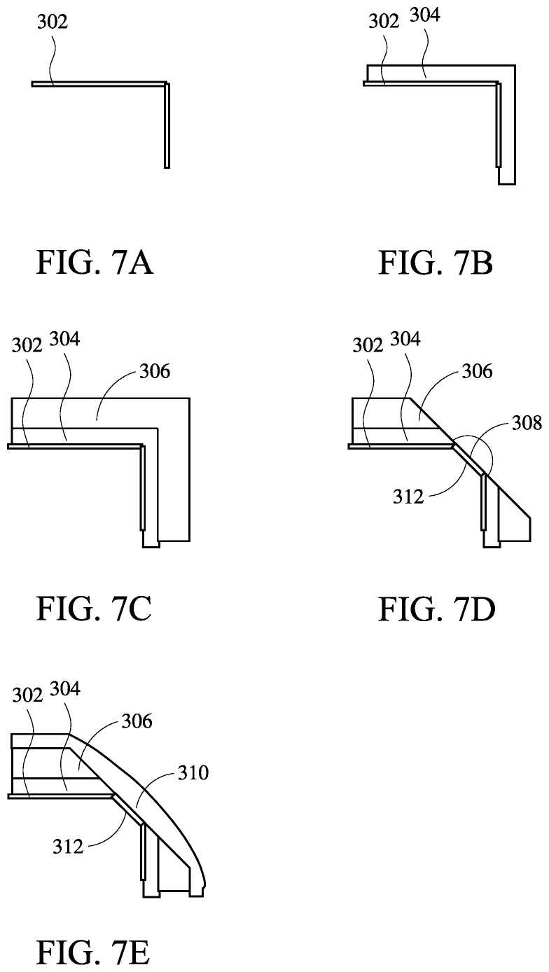

FIGS. 7A to 7E show the sectional view of structure corresponding to the magnesium alloy object according to the third embodiment of the present invention shown in FIG. 3. The magnesium alloy object 302 is processed with micro-arc oxidation (MAO) or conversion coating treatment to form oxide film 304 on the surface of the magnesium alloy object 302, thus enhance corrosion protection function. The MAO-treated or coating-treated surface is sprayed with paint to form a fifth paint layer 306. According to one embodiment, a functional paint layer (the fifth paint layer) is arranged on the oxidized first surface, where the functional paint layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer. Therefore, the surface of the magnesium alloy object 302 can be protected. Afterward, part of the fifth paint layer 306/the passivation layer (the oxide film 304) is CNC high-gross cut away to expose metallic main body 308 of the magnesium alloy object 302 such that the exposed metallic main body 308 has high gross surface. The activity of the magnesium alloy object 302 is passivated and the magnesium alloy object 302 maintains high gross by using specific conversion coating solution such as phosphate, zirconate, organic/inorganic oxane mixed solution. All of the surface of the magnesium alloy object 302 is applied with UV protective paint to form the sixth paint layer 310. According to one embodiment, a functional paint layer (the sixth paint layer) is arranged on the oxidized first surface, where the functional paint layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer. Therefore, the surface of the magnesium alloy object 302 can be protected.

The surface of the magnesium alloy object 302 is provided with oxide film 304 to enhance corrosion protection function. The fifth paint layer 306 is arranged on the magnesium alloy object 302 with the oxide film 304, thus provide appealing appearance and protect the surface of the magnesium alloy object 302. Part of the fifth paint layer 306/the oxide film (passivation layer) 304 is cut away to expose the metallic main body 308 of the magnesium alloy object 302 and to form the cut portion 312 with high gross surface. The sixth paint layer 310 is arranged on the cut portion 312 to encapsulate/cover the metallic main body 308 of the magnesium alloy object 302 and the oxide film 304 to provide corrosion protection function.

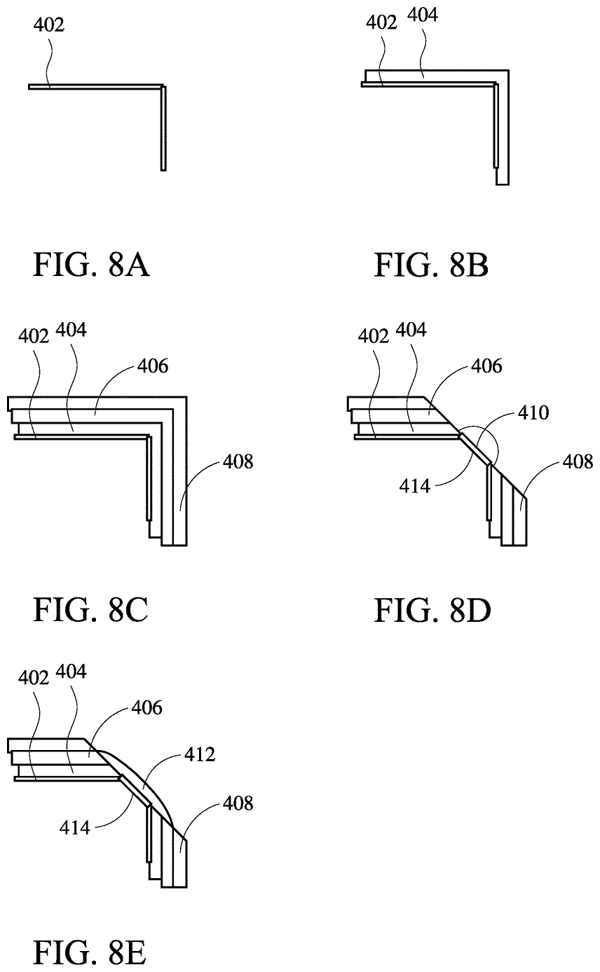

FIGS. 8A to 8E show the sectional view of structure corresponding to the magnesium alloy object according to the fourth embodiment of the present invention shown in FIG. 4. The magnesium alloy object 402 is processed with micro-arc oxidation (MAO) or conversion coating treatment to form oxide film 404 on the surface of the magnesium alloy object 402, thus enhance corrosion protection function. After the MAO or conversion coating treatment, the surface of the magnesium alloy object 402 is sprayed by conductive paint to form a conductive paint layer 406. A seventh paint layer 408 is sprayed on the conductive paint layer 406. According to one embodiment, a functional paint layer (the seventh paint layer) is arranged on the oxidized first surface, where the functional paint layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer. Therefore, the magnesium alloy object has appealing appearance and the surface thereof can be protected. Afterward, part of the seventh paint layer 408/the conductive paint layer 406/the passivation layer (oxide film) 404 is CNC high-gross cut away to form a cut portion 414 and to expose metallic main body 410 of the magnesium alloy object such that the exposed metallic main body 410 has high gross surface. The exposed metallic main body 410 with high gross surface is also electrically conductive. The activity of the magnesium alloy object 402 is passivated and the magnesium alloy object 402 maintains high gross by using specific conversion coating solution such as phosphate, zirconate, organic/inorganic oxane mixed solution. An eighth paint layer 412 is formed by ED process to protect the exposed metallic main body 410 with high gross surface.

The surface of the magnesium alloy object 402 is provided with oxide film 404 to enhance corrosion protection function. The magnesium alloy object 402 with oxide film 404 is also provided with the conductive paint layer 406 thereon. The seventh paint layer 408 is sprayed on the conductive paint layer 406 to enhance appearance. Part of the seventh paint layer 408/the conductive paint layer 406/the passivation layer (oxide film) 404 is removed to form the cut portion 414 and expose the metallic main body 410 with high gross surface and the high gross surface is electrically conductive. The eighth paint layer 412 is formed by ED process. According to one embodiment, a functional paint layer (the eight paint layer) is arranged on the oxidized first surface, where the functional paint layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer. Therefore, the high gross surface can be protected. The eighth paint layer 414 is arranged on the cut portion 414 to encapsulate/cover the metallic main body 410 of the magnesium alloy object 402, the conductive paint layer 406 and the oxide film 304 to provide corrosion protection function.

The magnesium alloy object according to the present invention is subject to micro-arc oxidation (MAO) or conversion coating treatment, painted with conductive paint, subject to CNC high-gross treatment and then painted with protective paint, and can achieve corrosion protection. Moreover, the high-gross surface of the magnesium alloy object is passivated and the passivated surface still has metallic gross. The magnesium alloy object is added with conductive layer to increase the ED coverage area and to enhance corrosion protection ability.

Although the present invention has been described with reference to the preferred embodiment thereof, it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. A high-gross manufacturing method for magnesium alloy object, the method comprising:
providing a magnesium alloy object;
performing micro-arc oxidation (MAO) or conversion coating treatment on the magnesium alloy object to form an oxide film on a surface of the magnesium alloy object;
spraying a paint layer on MAO-treated or conversion coating-treated surface of the magnesium alloy object to protect the magnesium alloy object;
performing CNC high gross cutting to cut away part of paint layer and part of the oxide film to expose a metallic main body of the magnesium alloy object;
using specific conversion coating solution to passivate the magnesium alloy object; and
spraying paint on an exposed surface of the magnesium alloy object to provide corrosion protection.

2. The method in claim 1, wherein the paint is sprayed on all surface of the magnesium alloy object.

3. The method in claim 1, wherein the specific conversion coating solution is phosphate, zirconate, organic oxane mixed solution or inorganic oxane mixed solution.

4. The method in claim 1, wherein the paint in the last step is electro-coating (ED) or UV-curable paint.

5. A high-gross manufacturing method for magnesium alloy object, the method comprising:
providing a magnesium alloy object;
performing micro-arc oxidation (MAO) or conversion coating treatment on the magnesium alloy object to form an oxide film on a surface of the magnesium alloy object;
using laser to remove part of the MAO-treated or conversion coating-treated surface of the magnesium alloy object to expose a metallic surface of the magnesium alloy object;
performing conversion coating treatment to the exposed metallic surface to passivate the magnesium alloy object;
spraying a conductive paint on the laser-treated and passivated metallic surface
spraying a paint on the magnesium alloy object to protect the magnesium alloy object;
cutting away part of the magnesium alloy object to expose a metallic main body;
using specific conversion coating solution to passivate the magnesium alloy object; and
spraying electro-coating (ED) or UV-curable paint on the magnesium alloy object to provide protection.

6. The method in claim 5, wherein the specific conversion coating solution is phosphate, zirconate, organic oxane mixed solution or inorganic oxane mixed solution.

7. A high-gross manufacturing method for magnesium alloy object, the method comprising:
providing a magnesium alloy object;
performing micro-arc oxidation (MAO) or conversion coating treatment on the magnesium alloy object to form an oxide film on a surface of the magnesium alloy object;
spraying a conductive paint on the MAO-treated or conversion coating-treated surface to form a conductive paint layer;
spraying a paint layer on the conductive paint layer;
CNC high-gross cutting part of the paint layer, part of the conductive paint layer and part of the oxide film to expose a metallic body, the metallic body having high-gross and conductive surface;
using specific conversion coating solution to passivate the magnesium alloy object; and
spraying electro-coating (ED) to protect high-gross surface.

8. The method in claim 7, wherein the specific conversion coating solution is phosphate, zirconate, organic oxane mixed solution or inorganic oxane mixed solution.

9. A high-gross magnesium alloy structure comprising:
a magnesium alloy object;
an oxide film arranged on a surface of the magnesium alloy object, a first paint layer arranged on the magnesium alloy object with the oxide film to protect the surface of the magnesium alloy object, a cut portion formed by cutting away part of the first paint layer and part of the oxide film to expose a metallic main body; and
a second paint layer arranged on the cut portion to provide corrosion protection.

10. The high-gross magnesium alloy structure in claim 9, wherein the second paint layer arranged on the cut portion encapsulates or covers the metallic main body of the magnesium alloy object and the oxide film.

11. The high-gross magnesium alloy structure in claim 9, wherein the first paint layer and the second paint layer are made from a functional coating layer on an oxidized first surface, and the functional coating layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer.

12. A high-gross magnesium alloy structure comprising:
a magnesium alloy object;
an oxide film arranged on a surface of the magnesium alloy object, a first paint layer arranged on the magnesium alloy object with the oxide film to protect the surface of the magnesium alloy object, a metallic surface formed by cutting part of the oxide film, a conductive paint layer arranged on the metallic surface;
a third paint layer arranged on the oxide film and the conductive paint layer to protect the magnesium alloy object;
a cut portion formed by cutting part of the conductive paint layer and part of the third paint layer to expose a metallic main body; and
a four paint payer arranged on the magnesium alloy object to provide corrosion protection.

13. The high-gross magnesium alloy structure in claim 12, wherein the third paint layer and the fourth paint layer are made from a functional coating layer on an oxidized first surface, and the functional coating layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer.

14. The high-gross magnesium alloy structure in claim 12, wherein the fourth paint layer arranged on the magnesium alloy object encapsulates or covers the metallic main body of the magnesium alloy object, the conductive paint layer and the third paint layer.

15. A high-gross magnesium alloy structure comprising:
a magnesium alloy object;
an oxide film arranged on a surface of the magnesium alloy object, a conductive paint layer arranged on the magnesium alloy object with the oxide film, a seventh paint layer arranged on the conductive paint layer;
a cut portion formed by cutting part of the seventh paint layer, part of the conductive paint layer and part of the oxide film; a metallic main body being exposed to form a high-gross surface with electric conductivity; and
an eight paint layer formed by electro-coating (ED) to protect high-gross surface and provide corrosion protection.

16. The high-gross magnesium alloy structure in claim 15, wherein the eight paint layer arranged on the cut portion encapsulates or covers the metallic main body of the magnesium alloy object and the conductive paint layer.

17. The high-gross magnesium alloy structure in claim 15, wherein the seventh paint layer and the eight paint layer are made from a functional coating layer on an oxidized first surface, and the functional coating layer comprises at least polymer selected from the group consisting of polystyrene, polyimide (PI), Polypropylene (PP), polyurethanes (PU), methylsilsesquioxane, polyethylene (PE), polystyrene silicone, butyl rubber, polyamide (PA), polycarbonate (PC), styrene-butadiene rubber, acrylate polymer, epoxy and fluoropolymer.
